(19) United States
(12) Patent Application Publication
(10) Pub. No.: US 2016/0071104 A1
(43) Pub. Date: Mar. 10, 2016

(54) SECUREBUY MERCHANT INFORMATION ANALYTICS DECISION ENGINE

(71) Applicants: George Gregory Stamatis, Pearl, MS (US); Jason Michael Napsky, Boynton Beach, FL (US); Lloyd William Briggs, Milwaukie, OR (US)

(72) Inventors: George Gregory Stamatis, Pearl, MS (US); Jason Michael Napsky, Boynton Beach, FL (US); Lloyd William Briggs, Milwaukie, OR (US)

(21) Appl. No.: 14/477,787

(22) Filed: Sep. 4, 2014

(51) Int. Cl. G06Q 20/40; G06Q 30/06

(52) U.S. Cl. CPC G06Q 20/4016; G06Q 20/405; G06Q 30/0609; G06Q 30/0635

(57) ABSTRACT

The present invention may comprise a system and method for processing electronic transactions over a network. The invention may also comprise gathering pertinent data using processes that run in the background, processing the data, and providing a merchant's enterprise platform or other suitable purchase processing system to present verified alternative purchasing opportunities to a purchaser.

### CROSS-REFERENCE TO RELATED APPLICATION

This application claims priority from U.S. Provisional Patent Application No. 61/873,506, filed on Sep. 4, 2013, the contents of which are incorporated herein by reference. This application claims priority from U.S. Provisional Patent Application No. 61/888,250, filed on Oct. 8, 2013, the contents of which are incorporated herein by reference.

### BACKGROUND OF THE INVENTION

Facilitating the purchase of goods and services utilizing electronic means, such as but not limited to, enterprise shopping cart platforms, gateways, and processing entity technology, is a method used by many businesses worldwide. Such purchasing processes may be accomplished when the merchant presents their catalog of goods and services to the consumer, who in turn, chooses the desired product and proceeds to and completes the checkout process presented by the merchant's shopping cart or check-out process platform, thereby consummating and completing the shopping experience. While the consumer may have selected the product or service from a catalog, and subsequently completed the purchasing cycle, it may not necessarily have been the most suitable good or service for that particular individual. Under current systems and processes, the merchant has no means, method, or opportunity to efficiently and effectively review the proposed transaction and present the purchaser with better and potentially more suitable alternatives, prior to the completion of the checkout process.

Accordingly, it is desirable to provide a system whereby the merchant is provided with the opportunity to present and provide the consumer with an option to select and purchase a more suitable good or service, based upon analytical data gathered during and prior to completion of the checkout process.

### SUMMARY OF THE INVENTION

In one aspect of the present invention, a method for transaction processing may comprise; requesting stored data from an Application Programming Interface (API), validating a request from the API, logging the request, querying to a database to retrieve data relevant to the request, interpreting the request, and generating output to a reporting API.

In another aspect of the present invention, a method for transaction processing may comprise; entering a checkout, entering payment information from a consumer, collecting device information from a merchant, sending the payment information along with the device information to a fraud scoring system, calculating a fraud score in a fraud decision engine, presenting the merchant with an authentication method, and generating an order review page.

In yet another aspect of the present invention, a method for transaction processing may comprise; sending a CNP authorization and authentication to a decision engine, sending data from an API to a business logic layer, validating the data and sending the data to an appropriate gateway specific component, sending an authorization request to a gateway, sending authorization results to the appropriate gateway specific component, and parsing the authorization results.

These and other aspects, objects, features and advantages of the present invention, are specifically set forth in, or will become apparent from, the following detailed description of an exemplary embodiment of the invention.

### BRIEF DESCRIPTION OF THE DRAWINGS

The above and other aspects of the present invention will become more apparent by the following detailed description of exemplary embodiments thereof with reference to the attached drawings, in which:

FIG. 1 is a schematic block diagram of a system for processing electronic transactions over a network, according to an embodiment of the present invention;

FIG. 2 is a flow chart of an exemplary method of electronic processing of transactions, according to a further embodiment of the present invention;

FIG. 3 is a flow chart of an exemplary method of electronic processing of transactions, such as a digital receipt generation process, according to another embodiment of the present invention;

FIG. 4 is a flow chart of an exemplary method of electronic processing of transactions, such as implementing a reporting API, according to another embodiment of the present invention; and

FIG. 5 is a block diagram of an exemplary system, according to a still further embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention pertains to a manner of processing electronic transactions performed over a network, “online,” or via a number of electronic transaction processing tools that allow for retail or other transactions. The invention relates more particularly to the gathering of pertinent data utilizing processes that run in the background, processing the data, and providing the merchant's enterprise platform or other suitable purchase processing system with a means to present verified alternative purchasing opportunities to the purchaser.

In one embodiment, there is provided an Active Transaction Mode, in which the merchant presents their catalog of goods and/or services to the consumer (purchaser), who in turn, selects the desired product and proceeds to the associated checkout process presented by the merchant's enterprise platform or other suitable checkout system. This can be done through well known means via a website, application, or other electronic means. The consumer (purchaser) completes their part of the process by providing the appropriate identification/delivery information and presents their payment method, which is verified through a series of background analytical processes intended to ensure that the person is whom they claim to be and that the payment method is valid (i.e., authentication and verification). According to the present invention, the transaction can then proceed to completion after successful checking, or, the consumer may be presented with purchase alternatives, depending upon input provided by a SecureBuy Analytics Decision Engine prior to completion of the checkout process.

The SecureBuy Analytics Decision Engine performs the above mentioned analytical processes by accessing available consumer databases and sources such as, but not limited to, consumer credit bureaus, cardholder analytics, social media, and purchase history repositories. Said analytical data and metrics are then parsed and processed through a dynamic network of decision matrices that match up the pending purchase with the consumer's purchase history and credit worthiness along with other merchant selectable criteria.

Upon achieving a high degree of confidence that the consumer is a match, an output score, or other appropriate form of data string from the SecureBuy Analytics Decision Engine Matrices, is then transmitted to the merchant's enterprise platform, or other suitable purchasing system, in near real-time, regarding the potential opportunity to provide the consumer with an option to select and purchase a better, more suitable product, including associated products and/or accessories prior to completing the purchasing or checkout process. For example, if a consumer is determined to have high credit and purchase history suggests that the consumer prefers a particular quality of good or service, one or more alternative items (such as better quality items) from the merchant's electronic inventory can be identified that may be presented to the consumer prior to completion of the transaction.

The owner of the present invention offers a Real-Time Next Generation Passive Authentication, which may be a cloud-based application deployed at the payments level. This risk-based passive authentication platform provides an effective first perimeter of defense for transaction security from cybercrime. The next generation passive authentication engine executes immediately upon entry of the shopping cart and analyzes myriad attributes or a combination in the trillions to detect any anomalies or red flags.

In real-time or near real-time, the authentication engine is configured to query shared data with, for example, merchants, end-user computers and mobile devices. It can be configured to review email and device black-lists and search for hidden proxies, scripted attacks and cookie and browser manipulation. It can analyze and evaluate the actual device, type of operating system and browser in use, all within milliseconds. The risk-based engine can audit how many times the card has been used in the last 24 hours, last 3 days, and last week. From this analysis, it can be determined where the person is located, what device and/or browser they are using, and whether or not fraud has previously been perpetrated. The scoring engine provides a score and depending on the rules set, can determine whether to invoke active authentication. The information may also be used to determine whether and to what extent additional products or services can be presented.

A data push of additional products or services, as determined by merchant selectable criteria, would then append the checkout process prior to completion of the transaction and checkout process.

In another representative embodiment, Post Transaction Mode, the merchant electronically presents their catalog of goods and/or services to the consumer (purchaser), who in turn, chooses the desired product and proceeds to the associated checkout process presented by the merchant's enterprise platform or other suitable checkout system.

The consumer (purchaser) completes their part of the process by providing the appropriate identification/delivery information and presents their payment method, which is verified through a series of background analytical processes intended to ensure that the person is whom they claim to be and that the payment method is valid. The transaction then proceeds from there to completion; or the consumer may be presented with purchase alternatives, depending upon input provided by the SecureBuy Analytics Decision Engine, prior to completion of the checkout process.

The SecureBuy Analytics Decision Engine performs the above mentioned analytical processes by accessing available consumer databases and sources such as, but not limited to, consumer credit bureaus, cardholder analytics, social media, and purchase history repositories. Said analytical data and metrics are then parsed and processed through a dynamic network of decision matrices that match up the pending purchase data with the consumer's purchase history and credit worthiness, along with other merchant selectable criteria.

The purchase transaction is completed and an automatic follow-up marketing campaign via email or other appropriate means may be initiated. A data push of additional products or services, as determined by merchant selectable criteria, would then be inserted into, append or accompany said follow-up marketing and sales communications and/or literature.

For example, co-owned U.S. Pat. No. 7,916,906, the entire contents of which are incorporated herein by reference, describes a signature capture system that captures a biometric signature during electronic transaction processing. The present invention could be implemented with this system by introducing processing during the verification process but prior to completion of the transaction.

Co-owned U.S. patent application Ser. No. 13/605,095, filed Sep. 6, 2012, the entire contents of which are incorporated herein by reference, describes an electronic transaction system that includes authentication and verification. The present invention could be implemented with this system by introducing processing during the verification process but prior to completion of the transaction.

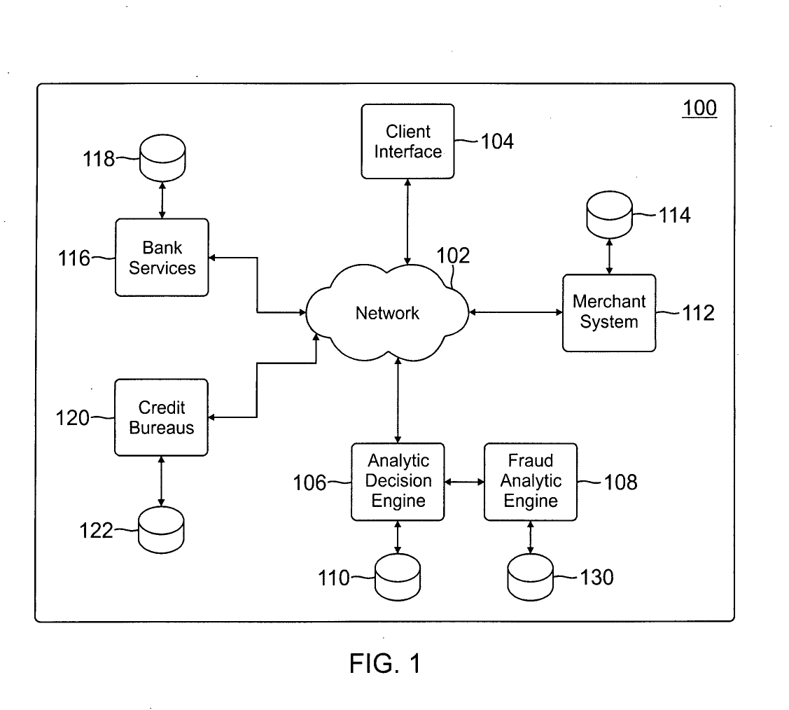

FIG. 1 is a high-level block diagram of an exemplary system 100 that may implement the present invention. A client interface 104 may communicate with a network 102, which may be any type of wired or wireless network. The invention may further comprise an analytics decision engine 106 in communication with the network 102 and a database 110. A fraud data server 108 may communicate with the analysis decision engine 106. A merchant system 112 useful for implementation in the system 100 may be in communication with the network 102 and a database 114. Bank services 116, such as card issuers, may be in communication with the network 102 and a database 118. Credit bureaus 120, connected to at least one database 122, may communicate with the network 102. It should be readily apparent that the present invention may be applied to existing online or other electronic commerce applications.

One purpose of this system is to facilitate the purchase of good and services. The feature leverages the data in the consortium database 130 populated by the fraud scoring 108 system as well as other data sources such as, but not limited to, credit bureaus 120, social media, and FICO score.

This process can be used during the checkout process to present the consumer with alternate and/or additional products. It can also be used post checkout or after cart abandonment using communication methods such as, but not limited to, email, SMS, MMS, and social media.

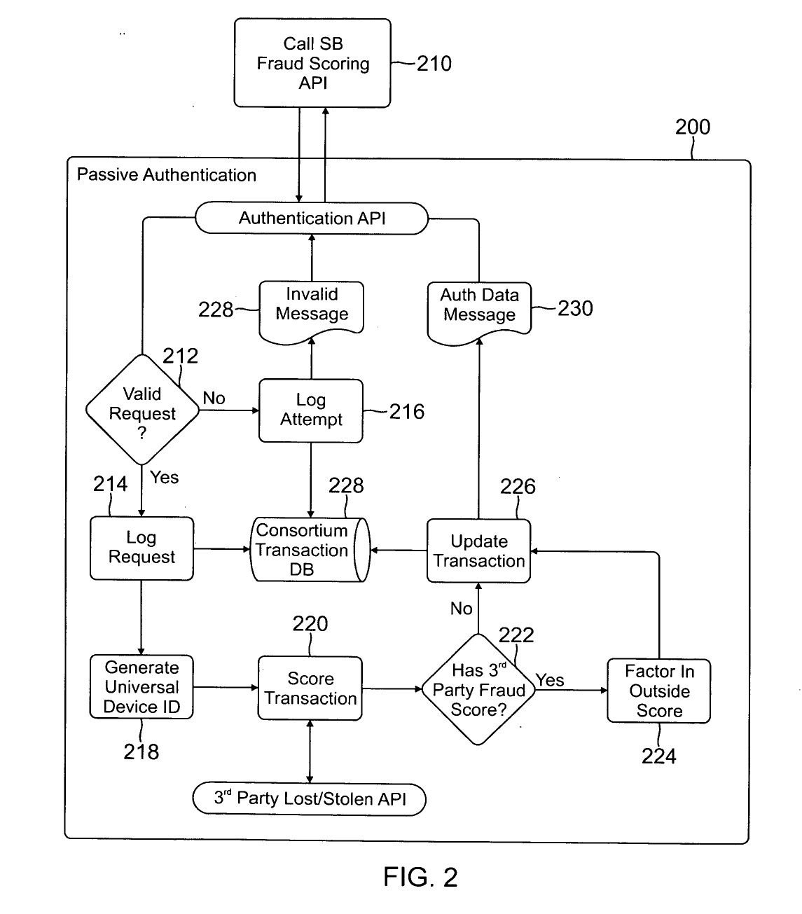

FIG. 2 is a high-level order flow of an exemplary process that may implement a fraudulent authorization process of the present invention. FIG. 2 shows the internal flow of the fraud score API. Merchants may use the flow to determine the risk level for a commerce transaction by means of a fraud score. The service may include a universal device ID generator that can be used with other third party device profiling service providers or stand alone. Some device profiling service providers may provide a fraud score for factoring into an overall fraud score. Also, lost/stolen card list services may be used by card issuers and card associations or other service providers to augment a fraud score. The method 200 may comprise various steps. For example, step 212 may present a decision interpreting the validity of an original request (step 210). Steps 214 and 216 may represent an action logging the result of the decision (212). Step 218 may represent an action for generating a universally unique ID for the device data received from the request to the Application Programming Interface (API) identified at step 210. Step 220 may represent an action attempting to generate a fraud score resulting from interpretation of the data received from the API request identified at step 210. Decision 222 may represent an interpretation of the data received from the API request (identified at step 210) attempting to identify a third party Device Profile Service Provider (DPSP) as having provided the device data received in the API request. Step 224 may represent an action to factor the device data provided by a third party DPSP into the score result generated at step 218. Step 226 may represent an action for updating a recorded transaction with score results derived at steps 218 and 224. Responses 228 and 230 may represent appropriate responses to the API request identified at step 210.

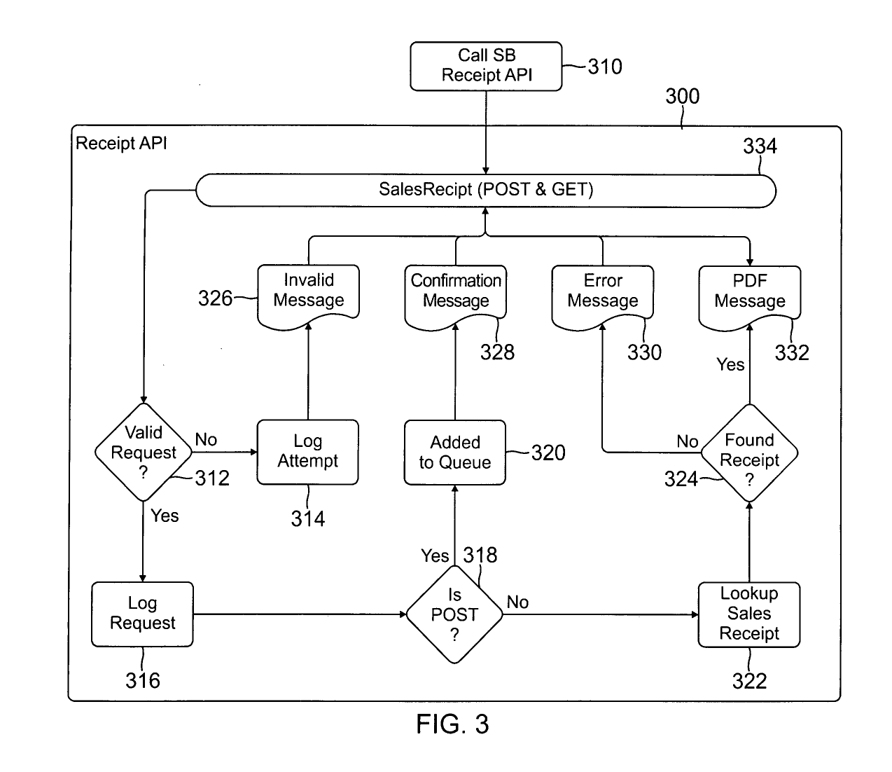

FIG. 3 is a high-level order flow of an exemplary process that may implement the digital receipt generation process of the present invention. FIG. 3 outlines a sales receipt flow. Merchants may use the flow to generate a sales receipt for a transaction. A sale receipt input may include optional results (such as in HTML) from a SecureBuy Screen Scrape solution. An API may be used in non-commerce scenarios, such as to capture a user's screen at the time of form submission. Including a screen scrape solution may enhance tracking of a web user's experience on a web site. With some enhancements one may generate a video of a user's exact experience on the web site, from what the user say and how the user moved a mouse to how the user scrolled on each page. Such a situation would give a web site an enhanced view into the user's experience and behavior, especially for ascertaining shopping behavior. The method 300 may comprise various steps. For example, step 310 may comprise calling SB receipt API, such as part of a checkout process. A step 320 may comprise a capture of consumer data while a step 312 may comprise authentication/verification, while results may be logged in steps 314 and 316. An option 318 may comprise deciding whether a request to add a new data capture or retrieve an existing capture. Step 322 may comprise retrieving existing consumer data. Step 324 may comprise a decision following the identification of existing consumer data. Steps 326, 328, 330, and 332 may comprise presenting the caller with a message appropriate to the request. Step 334 may comprise compiling a sale receipt.

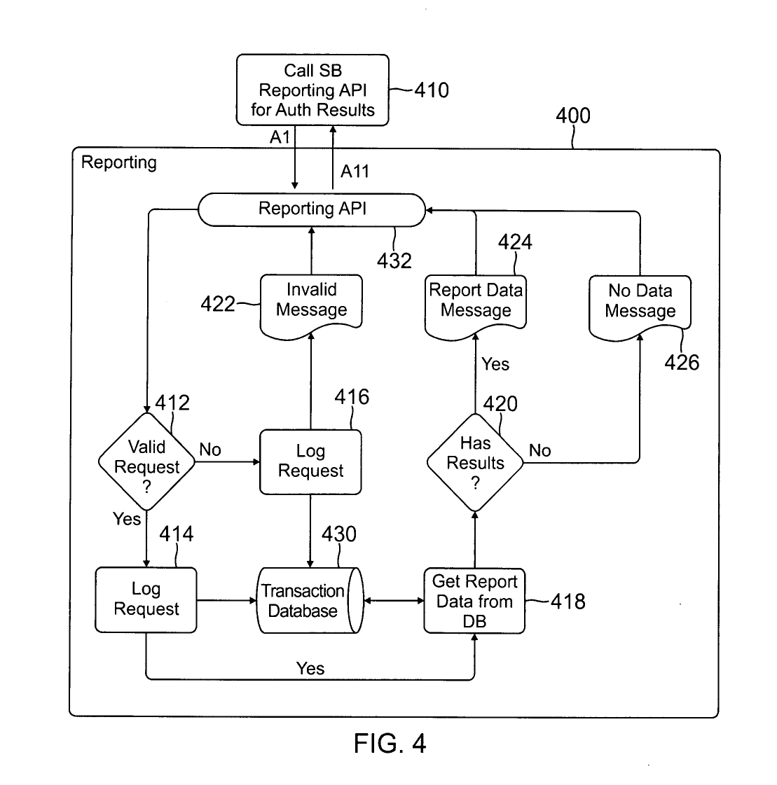

FIG. 4 is a high-level order flow of an exemplary process that may implement a reporting API for the present invention. The method 400 may comprise various steps. For example, step 410 may comprise a request to an Application Programming Interface (API) for stored data. A step 412 may represent a decision being made for a valid request to the API. Steps 414 and 416 may represent an action for logging the request. Step 418 may represent a query to a database retrieving data relevant to the initial request (410). Decision 420 may represent an interpretation of the query from step 418. Outputs 422, 424, and 426 may represent appropriate responses to the original API request (410) after processing the data from original request (410). Step 430 may comprise communication with a transaction database. Step 432 may comprise communication with a reporting API.

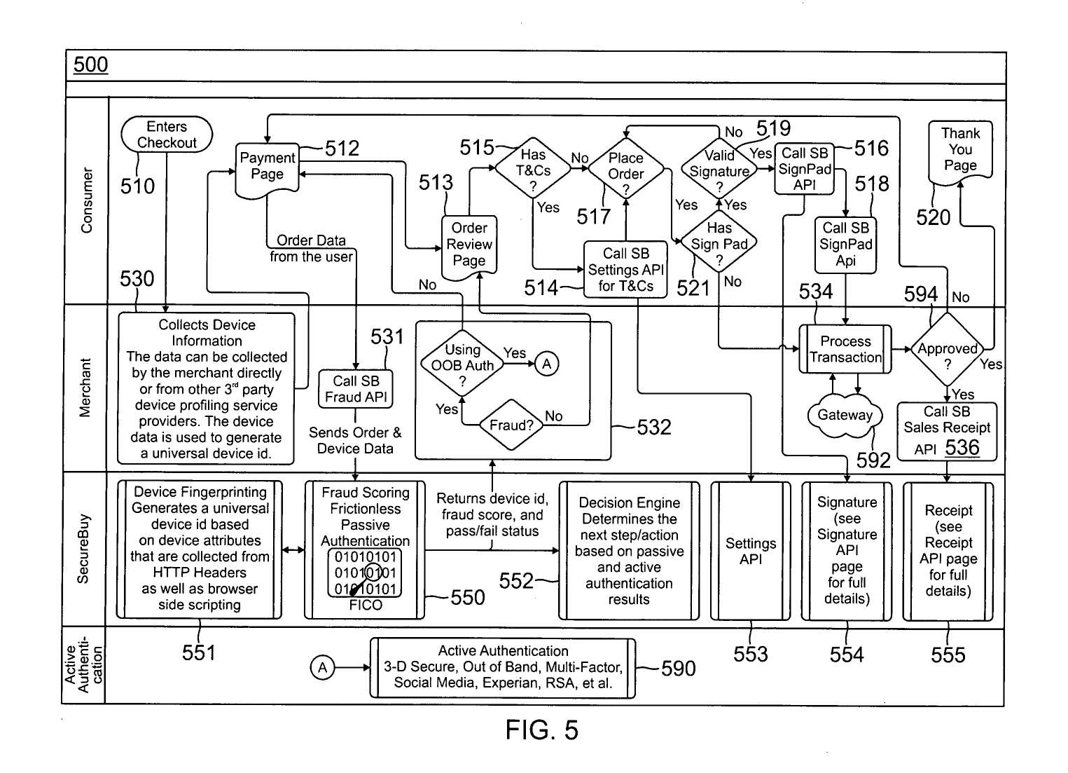

FIG. 5 is a high-level block diagram of an exemplary system 500 that may implement the present invention. A consumer may enter the system 500 during a shopping experience on a merchant's web site. A consumer may enter checkout at step 510. During the shopping experience, data about a consumer's device and browser may be collected at step 530. The consumer may enter payment information at step 512. Payment information along with device data from step 530 may be sent to a fraud scoring system in step 550. The path of data flow may comprise calling SB fraud API in step 531. The fraud scoring system 550 may work in conjunction with a Universal Device Profiling and Fingerprinting service in step 551 to accurately identify the consumer and generate a fraud score while reducing false positives. The fraud score may be consummated by a Fraud Decision Engine in step 552 to determine a step and/or an action. Depending on the fraud score and the merchant's configurations in step 532 the Fraud Decision Engine may present the merchant and/or consumer with an active authentication method in step 590 for the consumer to prove they are who they are claiming to be. During the checkout process the merchant may present the consumer with terms and conditions. An order may be reviewed in step 513, where the system 500 may generate an order review page. The terms and conditions may be requested in step 514 from a service in step 553, such as wherein the system 500 is used to store, maintain, and record changes to the merchant's terms and conditions. Possession of the terms and conditions may be determined in step 515. A decision whether to place an order may occur in step 517. Step 519 may comprise verifying whether a signature is valid. Step 521 may comprise deciding whether a sign pad is present. The system 500 may support the use of signature capture in step 516 and step 554 as a means to provide proof of acceptance of the order and/or terms and conditions. During the checkout process the merchant may request payment authorization in step 534 from a gateway 592 or other payment system. A decision of approval may occur in step 594, optionally after calling SB sales receipt API in step 536. The system may support a sales receipt in step 555 with a service leveraging the screen scrape functionality in step 518 to generate a sales receipt. The receipt process may comprise step 536 of calling SB sales receipt API in step 536. The merchant may present a page in step 520 to the consumer to confirm that the order has been received and is being processed (such as, an “order receipt page” or “thank you page”).

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein.

1-4. (canceled)

5. A system for generating a record of a transaction, the system comprising:
a computer interface module that records movement of a cursor on a device screen, collects device information from a merchant, and outputs the recorded data;
a signature generation module that receives said recorded data and generates a graphical image of a biometric signature based upon said recorded data;
a screen scrape module configured to create an electronic file containing information corresponding to the display information on the device screen and to transmit said electronic file to a remote server, said server being configured to generate an uneditable computer file containing the information corresponding to said display information;
a fraud scoring system for receiving payment information entered from a consumer; and
a fraud decision engine for calculating a fraud score.

6. The system of claim 5, wherein said electronic file is HTML and data.

7. A computer implemented method for capturing an online electronic, biometric signature for an online transaction, said method comprising steps of:
collecting payment information via a client computer interface from a consumer;
receiving electronically a signature program at said client computer interface from a second party;
executing said signature program module to display a signature block on the client computer interface, said signature program being capable of capturing biometric signature data from a computer input peripheral device of said client computer interface;
said signature program module receiving signature data from said computer peripheral device representing a biometric signature;
generating a graphical image of said biometric signature from said signature data;
storing at least one of said signature data and said graphical image remotely at data storage facilities at said second party, with data relating to said online transaction;
when that said at least one of said signature data and said graphical image is stored with data relating to said online content at data storage facilities at said second party, transmitting a notification to said first party and said client computer interface indicating that the signature has been received;
sending payment information to fraud scoring system; and
generating a fraud score via a fraud decision engine;
wherein said program module is executed independently from said online content; and
wherein said computer client interface includes a hosting application for displaying said online content to a computer user, and step of executing said program module includes a step of downloading said signature program module from a location different than a location where said online content is stored based on an embedded command in said online content, said signature program module configured to display the signature block on the client computer interface and capture the signature data from a computer peripheral device.

8. The method of claim 7, wherein said step of executing said program module includes a step of downloading a signature block program based on link embedded in said online content, said signature block program configured to display the signature block on the client computer interface and capture the signature date from a computer peripheral device.

9. The method of claim 7, wherein said signature block module comprises included in said hosting application.

10. The method of claim 7, wherein said signature block module comprises embedded in said online content.

11. A computer implemented method for capturing an onilne electronic, biometric signature for an online transaction, said method comprising steps of:
in connection with an online electronic transaction, at a client device interface configured to display content for said online electronic transaction, executing a signature program configured to display a signature block on said client device interface, to receive biometric signature data input fro said client device interface, and to capture biometric siganture data and associate said biometric signature with said online electronic tansaction;
electronically transmitting said captured biometric signature data in association with said online electronic transaction to a storage facility;
electronically transmitting to said client device interface and to a party associated with said online electronic transaction a notification indicating that the said biometric signature data has been received;
entering consumer payment information;
retrieving device data and browser data from a consumer's device;
transmitting the consumer payment information, device data, and browser data from the consumer's device to a fraud scroing system;
identifying the consumer;
generating a fraud score by a fraud decision engine;
presenting a merchant with an active authentication method; and
presenting the consumer with a page to confirm receipt of an order.

12. The method of claim 11, wherein said signature program is identified by a link in said content for said online electronic transaction.

13. The method of claim 11, wherein said signature program is preinstalled on said client computer interface.

14. The method of claim 11, further comprising a step of generating an electronic representation of the signature from said biometric signature data.

15. The method of claim 14, wherein said electronic representation of the signature is an image.
